(19) United States
(12) Patent Application Publication
(10) Pub. No.: US 2016/0253118 A1
(43) Pub. Date: Sep. 1, 2016

(54) ELECTRONIC DEVICE, CONTROLLING METHOD, AND STORAGE MEDIUM

(71) Applicant: KABUSHIKI KAISHA TOSHIBA, Tokyo (JP)

(72) Inventor: Shuji HORI, Iruma Saitama (JP)

(21) Appl. No.: 14/920,754

(22) Filed: Oct. 22, 2015

Related U.S. Application Data
(60) Provisional application No. 62/121,048, filed on Feb. 26, 2015.

(51) Int. Cl. G06F 3/06

(52) U.S. Cl. CPC G06F 3/0622; G06F 3/0637; G06F 3/0688

(57) ABSTRACT

According to one embodiment, an electronic device includes a storage device and a processor. The storage device includes a storage and a first nonvolatile memory configured to store first data indicative of the number of times the storage device has been turned on. The processor stores the first data as second data in a second nonvolatile memory before the storage device is turned off, and when the storage device is turned on, determines whether access to the data in the storage is permitted based on a first number indicated by the first data and a second number indicated by the second data prior to the access to the data in the storage.

### CROSS-REFERENCE TO RELATED APPLICATIONS

This application claims the benefit of U.S. Provisional Application No. 62/121,048, filed Feb. 26, 2015, the entire contents of which are incorporated herein by reference.

### FIELD

Embodiments described herein relate generally to an electronic device comprising a removal storage device.

### BACKGROUND

Computers comprise storage devices for storing, for example, operating systems, application programs and document files. In general, storage devices are removal from computers.

A malicious third party can remove a storage device from a computer and plant a computer virus or spyware on the storage device. If the storage device on which the virus or spyware has been planted is replaced in the original computer, and the computer is booted, the computer is booted as normal. Therefore, there is a high possibility that data on the network connected to the computer is leaked by the spyware, or the virus or spyware is spread to other computers connected to the network.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary block diagram showing a configuration of a system according to an embodiment.

FIG. 2 is an exemplary block diagram showing a system configuration of an electronic device shown in FIG. 1.

FIG. 3 is an exemplary flowchart showing a procedure of a process of transitioning the electronic device from an active state to an inactive state.

FIG. 4 is an exemplary flowchart showing a part of a procedure of a process of transitioning the electronic device from an inactive state to an active state.

FIG. 5 is an exemplary flowchart showing another part of the procedure of the process of transitioning the electronic device from an inactive state to an active state.

FIG. 6 is an exemplary flowchart showing another part of the procedure of the process of transitioning the electronic device from an inactive state to an active state.

FIG. 7 is an exemplary flowchart showing another part of the procedure of the process of transitioning the electronic device from an inactive state to an active state.

FIG. 8 is an exemplary flowchart showing another part of the procedure of the process of transitioning the electronic device from an inactive state to an active state.

FIG. 9 is an exemplary flowchart showing another part of the procedure of the process of transitioning the electronic device from an inactive state to an active state.

FIG. 10 is an exemplary flowchart showing a procedure of a process of transitioning the electronic device from an active state to an inactive state.

FIG. 11 is an exemplary diagram showing a screen for requesting user password input.

FIG. 12 is an exemplary diagram showing a screen for notifying the user that there is a possibility that an HDD (SSD) was removed.

FIG. 13 is an exemplary diagram showing a screen for notifying the user that a return or boot process is continued if key input is performed.

FIG. 14 is an exemplary diagram showing a screen for notifying the user of the necessity of power-off if there is a problem.

FIG. 15 is an exemplary diagram showing a screen for requesting supervisor password input.

FIG. 16 is an exemplary diagram showing a screen for allowing the user to select a process.

### DETAILED DESCRIPTION

Various embodiments will be described hereinafter with reference to the accompanying drawings.

In general, according to one embodiment, an electronic device includes a storage device, a second nonvolatile memory and a processor. The storage device includes a storage and a first nonvolatile memory configured to store first data. The first data indicates the number of times the storage device has been turned on. The processor is configured to store the first data as second data in the second nonvolatile memory before the storage device is turned off, and when the storage device is turned on, determine whether access to the data in the data storage portion is permitted based on a first number indicated by the first data and a second number indicated by the second data prior to the access to the data in the storage.

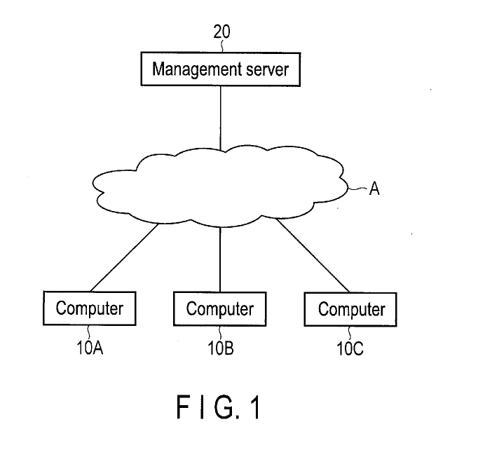

FIG. 1 is an exemplary diagram showing a configuration of a system.

The system includes an electronic device. The electronic device may be realized as a desktop computer. The electronic device may be also realized as a portable device powered by a battery, such as a tablet computer, a notebook computer, a smartphone or a PDA, or as an embedded system. Hereinafter, this specification assumes that the electronic device is realized as a desktop computer 10.

As shown in FIG. 1, computers 10A to 10C as electronic devices and a management server 20 as an external device are connected to a network A. The computers 10A to 10C are capable of notifying the management server 20 of a problem occurrence alert indicating the possibility of a problem when the self devices may have a problem.

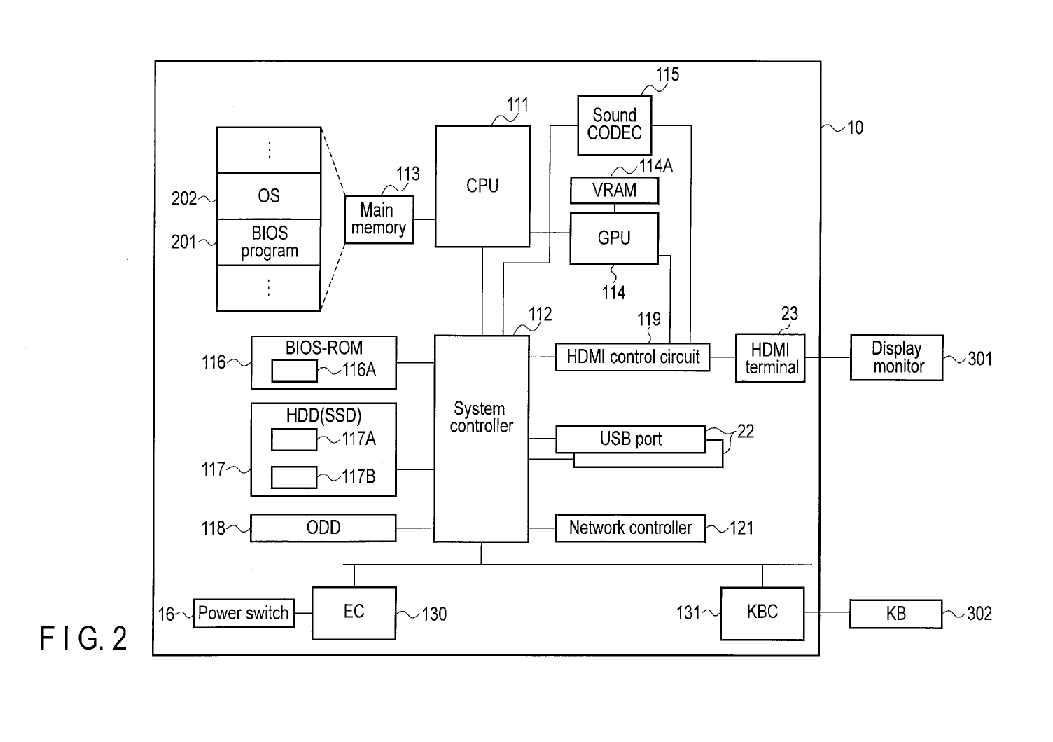

FIG. 2 is an exemplary block diagram showing a system configuration of the computer 10 (10A, 10B, 10C).

FIG. 2 shows the system configuration of the computer 10 according to the present embodiment. The computer 10 comprises, for example, a central processing unit (CPU) 111, a system controller 112, a main memory 113, a graphics processing unit (GPU) 114, a sound codec 115, a BIOS-ROM 116, a hard disk drive (HDD) (or a solid-state drive [SSD]) 117, an optical disc drive (ODD) 118, a network controller 121, an embedded controller (EC) 130 and a keyboard controller IC (KBC) 131. The HDD (SSD) 117 comprises, for example, a data storage portion 117A and a nonvolatile memory 117B for storing data.

The CPU 111 is a processor which controls the operation of each component of the computer 10. The CPU 111 executes various programs loaded from the data storage portion 117A of the HDD (SSD) 117 into the main memory 113. The programs include an operating system (OS) 202 and various application programs.

The CPU 111 also executes a Basic Input/Output System (a BIOS program 201) stored in the BIOS-ROM 116 which is a nonvolatile memory. The BIOS program 201 is a system program for hardware control.

The CPU 111 is capable of executing various processes in accordance with an instruction described in a program loaded into the main memory 113 connected to the CPU 111.

The GPU 114 is a display controller which controls a display monitor 301 used as a display device of the computer 10. The GPU 114 generates a display signal (HDMI video signal) which should be supplied to the display monitor 301 based on the display data stored in a video memory (VRAM) 114A. Further, the GPU 114 is capable of generating an analog RGB signal based on the display data. The analog RGB signal is supplied to an external display through an RGB port. An HDMI output terminal 23 is capable of transmitting an HDMI video signal (uncompressed digital video signal) and a digital audio signal to an external display through a single cable. An HDMI control circuit 119 is an interface for transmitting an HDMI video signal and a digital audio signal to the display monitor 301 via the HDMI output terminal 23.

The system controller 112 is a bridge device which connects the CPU 111 and each component. The system controller 112 comprises a built-in Serial ATA controller for controlling the HDD (SSD) 117 and the optical disc drive (ODD) 118.

The HDD (SSD) 117 as a storage device comprises a Self-Monitoring, Analysis and Reporting Technology (S.M.A.R.T.) function. The S.M.A.R.T. function is mounted in the HDD (SSD) 117 for the purpose of early detection of failure and prediction of trouble regarding the storage device. In the S.M.A.R.T. function, a plurality of values are stored in the nonvolatile memory 117B of the HDD (SSD) 117. An ID is allocated for each value stored in the nonvolatile memory 117B. The data associated with an ID 12 of the S.M.A.R.T. function indicates how many times the HDD (SSD) 117 has been turned on. Although the data associated with the ID 12 can be read externally, the data cannot be rewritten externally.

Devices such as a USB port 22 and the network controller 121 are connected to the system controller 112.

The system controller 112 executes communication with each device connected through a bus.

The EC 130 and the KBC 131 are connected to the system controller 112 through a bus.

The EC 130 is a power management controller for power management of the computer 10. The EC 130 comprises a function of turning on/off the computer 10 in accordance with a user's operation of a power switch 16.

The keyboard controller IC 131 controls input devices such as a keyboard (KB) 302 and a mouse.

The HDD (SSD) 117 is removable from the computer 10. A malicious third party can remove the storage device from the computer and plant a computer virus or spyware on the HDD (SSD) 117 when the computer 10 is in an inactive state such as a stopped state, a hibernation state or a sleep state. If the HDD (SSD) 117 having the computer virus or spyware is replaced in the original computer 10, and the computer 10 is booted, the computer 10 is booted as normal and transitions to an active state. If the computer 10 returns from a hibernation state or a sleep state, the computer 10 transitions to a normal active state.

Thus, there is a high possibility that data on the network A connected to the computer 10 is leaked by the spyware, or the virus or spyware is spread to other computers connected to the network A.

When the computer 10 transitions from an active state to an inactive state, the HDD (SSD) 117 is turned off. When the computer 10 transitions from an inactive state to an active state, the HDD (SSD) 117 is turned on. By turning the HDD (SSD) 117 on, the value of data corresponding to the ID 12 stored in the nonvolatile memory 117B is set to a value obtained by adding one to the original value.

Number A indicates the number of times the HDD (SSD) 117 has been turned on at the time of transitioning the computer 10 from an active state to an inactive state. Number B indicates the number of times the HDD (SSD) 117 has been turned on at the time of transitioning the computer 10 from an inactive state to an active state.

If the HDD (SSD) 117 is removed while the computer 10 is inactive, and the HDD (SSD) 117 is turned on in a different computer, number B is greater than the number obtained by adding one to number A.

Thus, it is possible to determine whether or not there is a possibility that the HDD (SSD) 117 was removed while the computer 10 was inactive by comparing number B with the number obtained by adding one to number A during the process of transitioning the computer 10 from an inactive state to an active state.

In the computer 10 of the present embodiment, during the process of transitioning the computer 10 from an active state to an inactive state, the BIOS program 201 stores, in an area 116A of the BIOS-ROM 116 which is a nonvolatile memory different from the nonvolatile memory 117B, data which is stored in the nonvolatile memory 117B and indicates how many times the HDD (SSD) 117 has been turned on. The process of transitioning the computer 10 from an active state to an inactive state includes a process of turning the HDD (SSD) 117 off.

The BIOS program 201 determines, during the process of transitioning the computer 10 from an inactive state to an active state in order to use data in the data storage portion 117A, whether or not use of data in the data storage portion 117A should be permitted based on: the number (number B) which is indicated by data stored in the nonvolatile memory 117B and indicates how many times the HDD (SSD) 117 has been turned on; and the number obtained by adding one to the number (number A) indicated by data stored in the area 116A of the BIOS-ROM 116. The BIOS program 201 controls the process of transitioning the computer 10 from an inactive state to an active state in accordance with the determination result.

If the value (number B) which is stored in the nonvolatile memory 117B and indicates how many times the HDD (SSD) 117 has been turned on is different from the value obtained by adding one to the value (number A) stored in the area 116A of the BIOS-ROM 116, the BIOS program 201 determines that use of data in the data storage portion 117A should not be permitted. The process of transitioning the computer 10 from an inactive state to an active state is stopped. The BIOS program 201 transitions the computer 10 to the inactive state applied before implementation of the transition to an active state, and turns the HDD (SSD) 117 off. Before transitioning the computer 10 to the inactive state, the BIOS program may notify the management server 20 communicable with the computer 10 that there is a possibility that the HDD (SSD) 117 was removed from the computer 10.

If the value (number B) which is stored in the nonvolatile memory 117B and indicates how many times the HDD (SSD) 117 has been turned on is different from the value obtained by adding one to the value (number A) stored in the area 116A of the BIOS-ROM 116, and a supervisor password is set, the BIOS program 201 may request supervisor password input. If the correct supervisor password has been input, the BIOS program 201 may allow the user to determine whether or not the computer should be transitioned to an active state (use of data in the data storage portion 117A should be permitted).

If the value (number B) which is stored in the nonvolatile memory 117B and indicates how many times the HDD (SSD) 117 has been turned on is equal to the value obtained by adding one to the value (number A) stored in the area 116A of the BIOS-ROM 116, the BIOS program 201 determines that use of data in the data storage portion 117A should be permitted. The BIOS program 201 continues the process of transitioning the computer 10 from an inactive state to an active state.

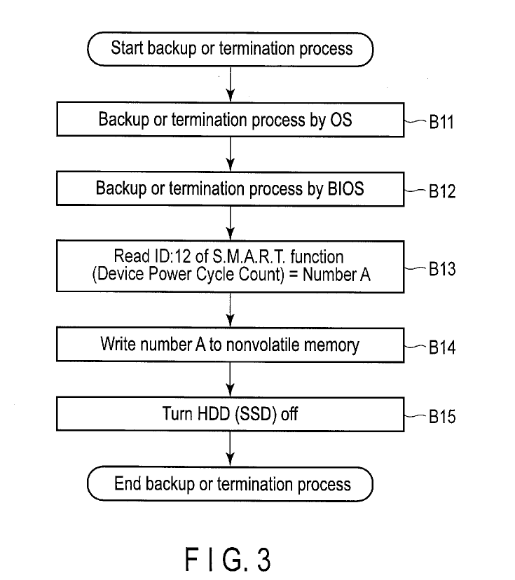

Now, this specification explains a process performed when the HDD (SSD) 117 is turned off while the computer 10 transitions from an active state to an inactive state with reference to FIG. 3. FIG. 3 is an exemplary flowchart showing the procedure of a process of transitioning the computer 10 from an active state to an inactive state.

The operating system 202 performs a backup process for transitioning the computer 10 to a sleep state or a hibernation state, or a termination process for shutting down the computer 10 (block B11). When the operating system 202 finished the backup process or the termination process, the BIOS program 201 performs a backup process for transitioning the computer 10 to a sleep state or a hibernation state, or a termination process for shutting down the computer 10 (block B12). The backup process or termination process includes preparation for turning the HDD (SSD) 117 off relative to the HDD (SSD) 117.

The BIOS program 201 requests the HDD (SSD) 117 to indicate the value which is associated with the ID 12 of the S.M.A.R.T. function and which shows how many times the HDD (SSD) 117 has been turned on. The HDD (SSD) 117 notifies the BIOS program 201 of the value associated with the ID 12 of the S.M.A.R.T. function. The BIOS program 201 receives the value associated with the ID 12 of the S.M.A.R.T. function (block B13). Hereinafter, the value which is associated with the ID 12 of the S.M.A.R.T. function and is read before power-off of the HDD (SSD) 117 may be referred to as number A.

The BIOS program 201 stores data indicating number A in the area 116A of the BIOS-ROM 116 (block B14). The BIOS program 201 turns the HDD (SSD) 117 off (block B15). Subsequently, the BIOS program 201 continues the process and shuts down the computer 10 or transitions the computer 10 to a sleep state or a hibernation state.

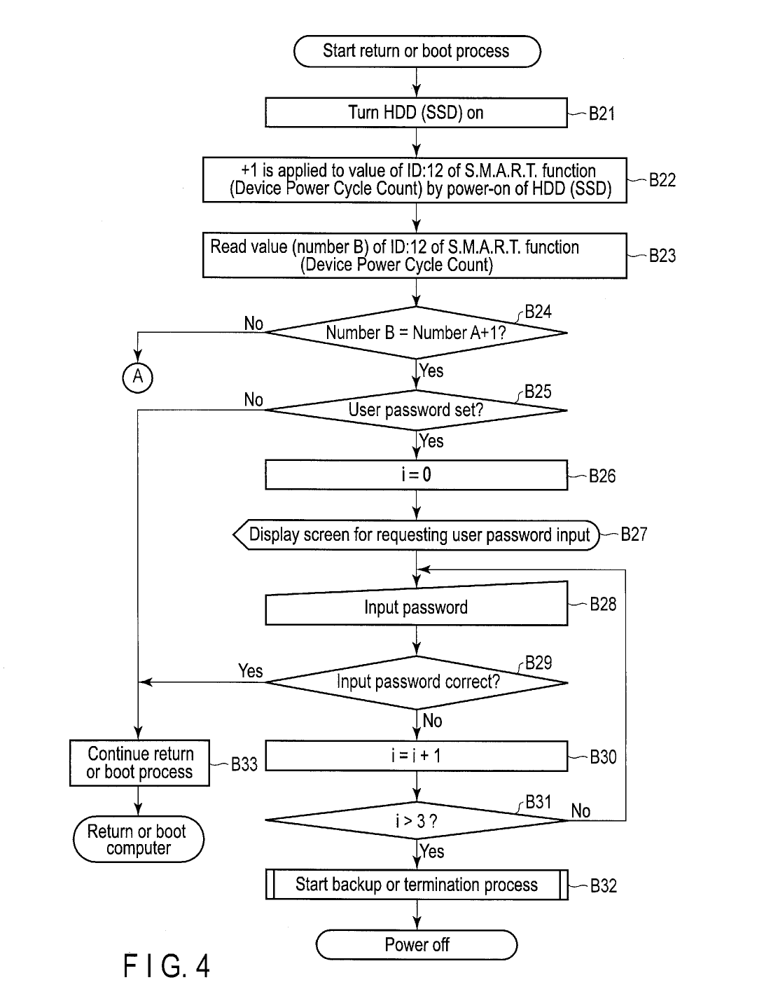

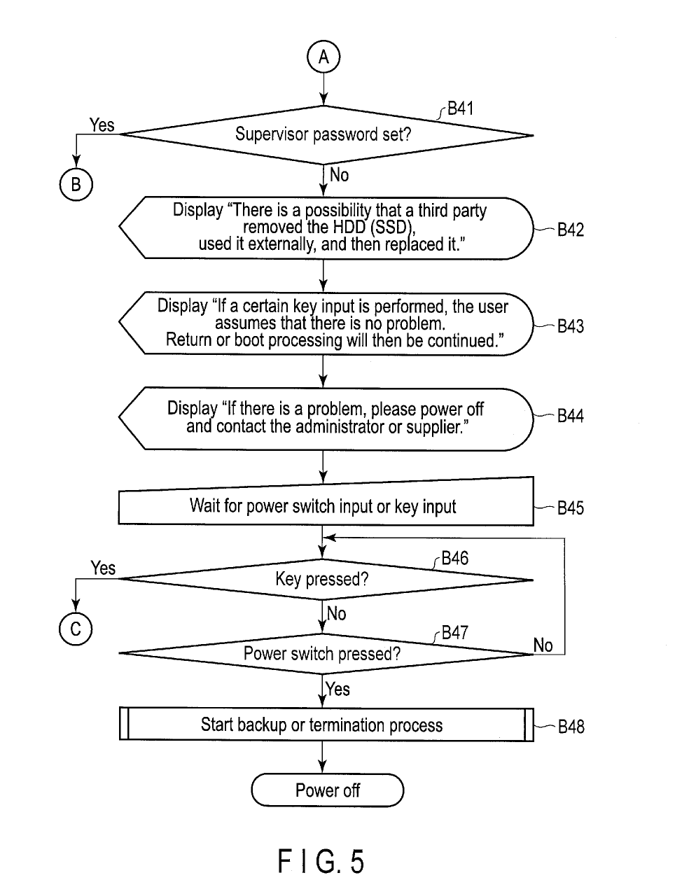

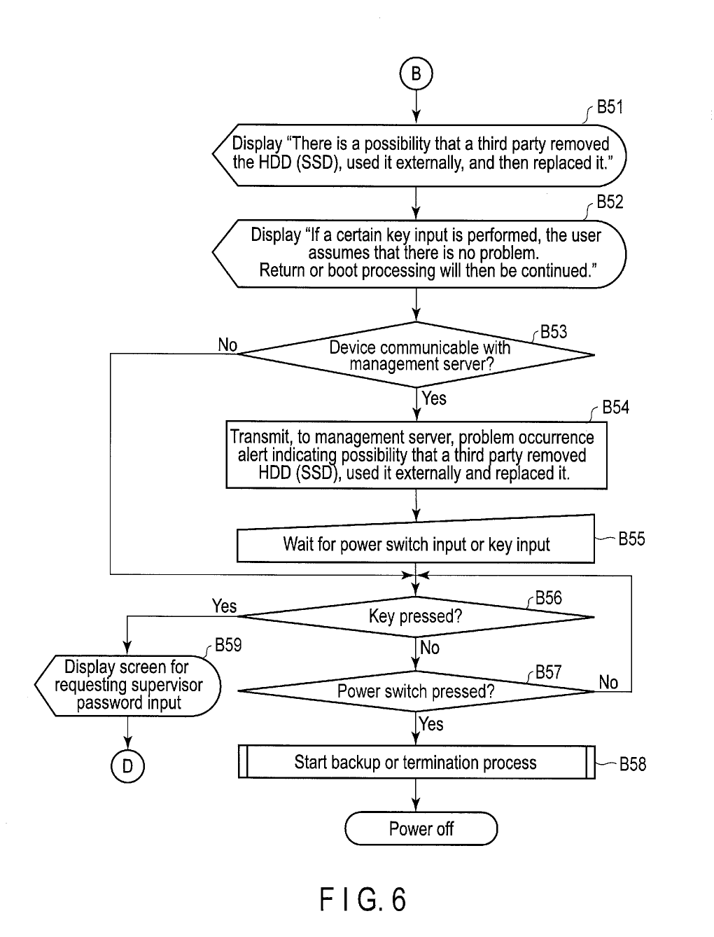

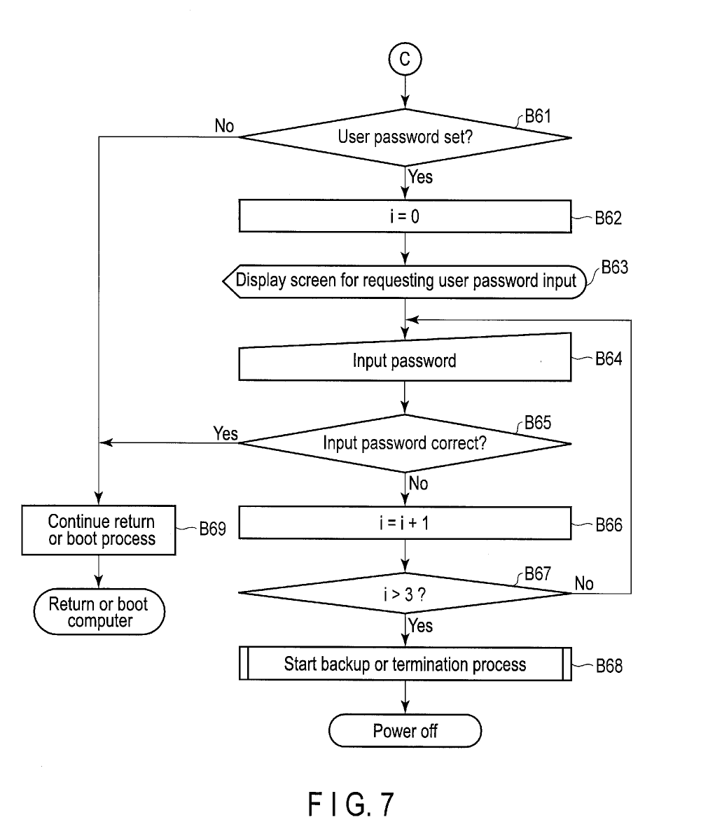

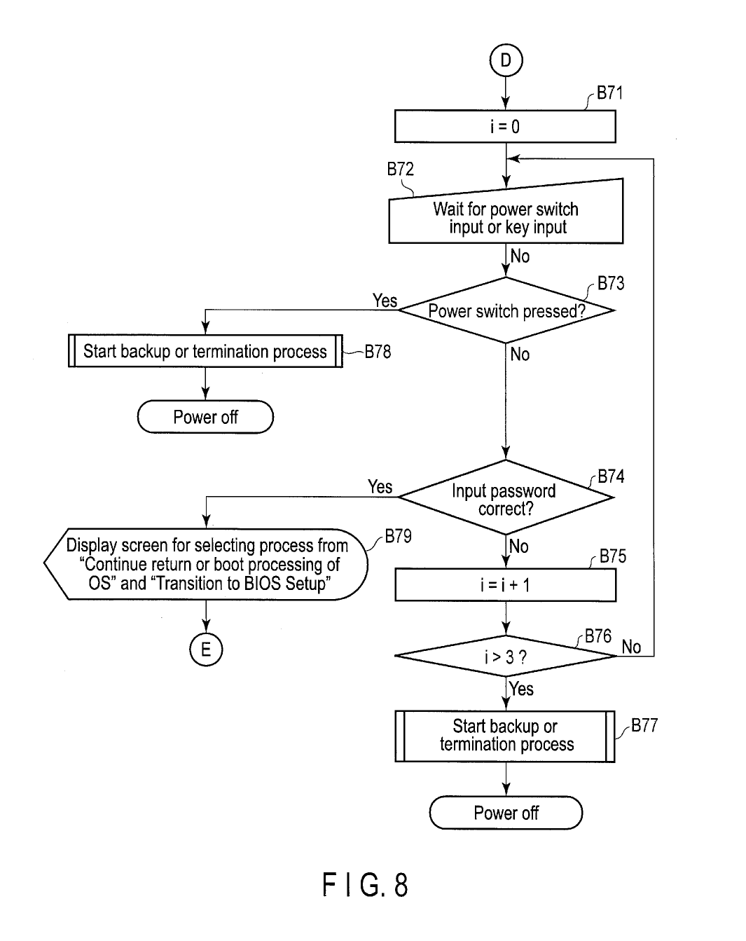

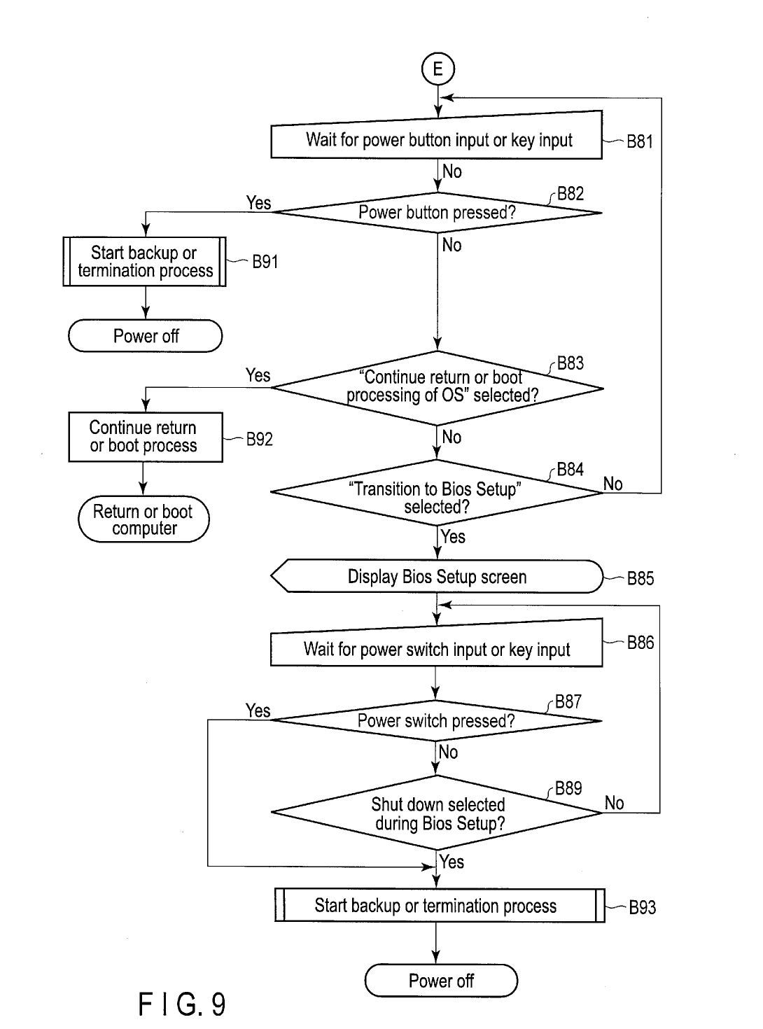

Now, this specification explains a process of transitioning the computer 10 from an inactive state to an active state with reference to FIG. 4, FIG. 5, FIG. 6, FIG. 7, FIG. 8 and FIG. 9.

The HDD (SSD) 117 is turned on (block B21). By the S.M.A.R.T. function of the HDD (SSD) 117, the value which is associated with the ID 12 and is stored in the nonvolatile memory 117B is set to the value obtained by adding one to the original value (block B22).

The BIOS program 201 requests the HDD (SSD) 117 to indicate the value associated with the ID 12 of the S.M.A.R.T. function. The HDD (SSD) 117 notifies the BIOS program 201 of the value associated with the ID 12 of the S.M.A.R.T. function. The BIOS program 201 receives the value associated with the ID 12 of the S.M.A.R.T. function (block B23). Hereinafter, the value which is associated with the ID 12 of the S.M.A.R.T. function and is read from the HDD (SSD) 117 during the process of transitioning the computer 10 to an active state may be referred to as number B.

The BIOS program 201 determines whether or not number B is equal to the value obtained by adding one to number A indicated by data stored in the area 116A (block B24). If the BIOS program 201 determines that number B is equal to the value obtained by adding one to number A (Yes in block B24), the BIOS program 201 determines whether or not a user password is set (block B25). The user password is so-called a BIOS password. If the BIOS program 201 determines that a user password is not set (No in block B25), the BIOS program 201 permits use of data in the data storage portion 117A and continues a return process of returning the computer 10 from a hibernation state or a sleep state, or a boot process of booting the computer 10 (block B33).

If the BIOS program 201 determines that a user password is set (Yes in block B25), the BIOS program 201 sets a value i indicating how many times a user password has been input to zero (block B26). The BIOS program 201 displays a screen for requesting user password input on a display screen 301A of the display monitor 301 as shown in FIG. 11 (block B27). The user inputs a user password, using the keyboard 302 (block B28). The BIOS program 201 determines whether or not the input user password is correct (block B29). If the BIOS program 201 determines that the input user password is correct (Yes in block B29), the BIOS program 201 continues the return process of returning the computer 10 from a hibernation state or a sleep state, or the boot process of booting the computer 10 (block B33).

If the BIOS program 201 determines that the input user password is incorrect (No in block B29), the BIOS program 201 sets the value i to the value obtained by adding one to the original value i (block B30). The BIOS program 201 determines whether or not the value i is greater than three (block B31). If the BIOS program 201 determines that the value i is not greater than three (No in block B31), the BIOS program 201 executes the process from block B28 in series. If the BIOS program 201 determines that the value i is greater than three (Yes in block B31), the BIOS program 201 performs a backup process for returning the computer 10 from an activate state to the original inactive state or a termination process as explained with reference to FIG. 3 (block B32).

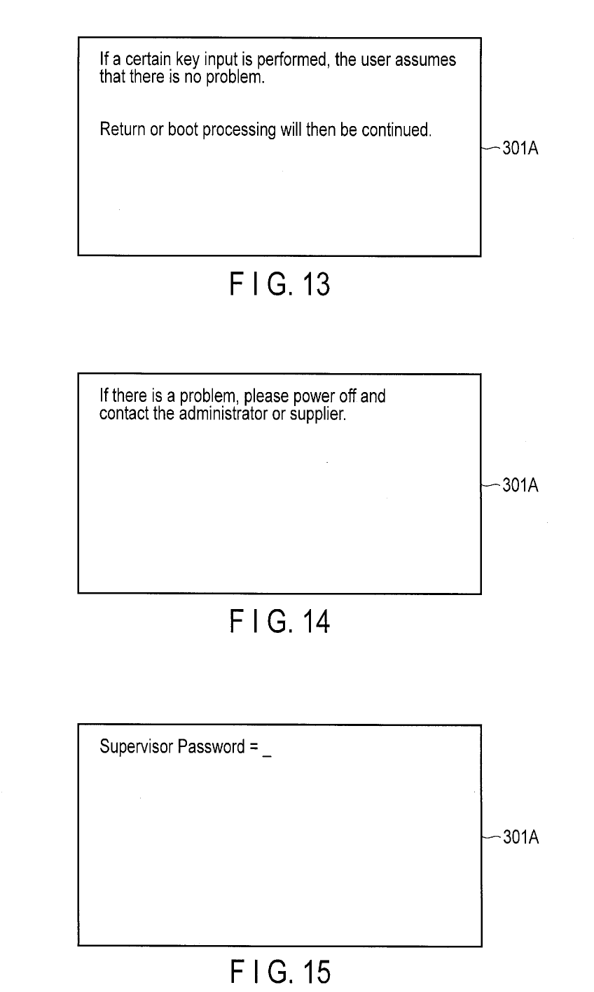

With reference to FIG. 5, this specification explains a process performed when the BIOS program 201 determines that number B is not equal to the value obtained by adding one to number A in block B24 (No in block B24). If the BIOS program 201 determines that number B is not equal to the value obtained by adding one to number A (No in block B24), the BIOS program 201 determines whether or not a supervisor password is set (block B41). If the BIOS program 201 determines that a supervisor password is not set (No in block B41), the BIOS program 201 displays the following message on the display screen 301A of the display monitor 301 as shown in FIG. 12 (block B42): “There is a possibility that a third party removed the HDD (SSD), used it externally, and then replaced it.” After a certain period, the BIOS program 201 displays the following message on the display screen 301A of the display monitor 301 as shown in FIG. 13 (block B43): “If a certain key input is performed, the user assumes that there is no problem. Return or boot processing will then be continued.” After another certain period, the BIOS program 201 displays the following message on the display screen 301A of the display monitor 301 as shown in FIG. 14 (block B44): “If there is a problem, please power off and contact the administrator or supplier.”

The BIOS program 201 waits for the power switch 16 or a key on the keyboard 302 to be operated (block B45). The BIOS program 201 determines whether or not a key has been pressed (block B46). If the BIOS program 201 determines that no key has been pressed (No in block B46), the BIOS program 201 determines whether or not the power switch 16 has been pressed (block B47). If the BIOS program 201 determines that the power switch 16 has not been pressed (No in block B47), the BIOS program 201 executes the process from block B46 in series after a certain period. If the BIOS program 201 determines that the power switch 16 has been pressed (Yes in block B47), the BIOS program 201 performs a backup process for returning the computer 10 from an active state to the original inactive state, or a termination process (block B48).

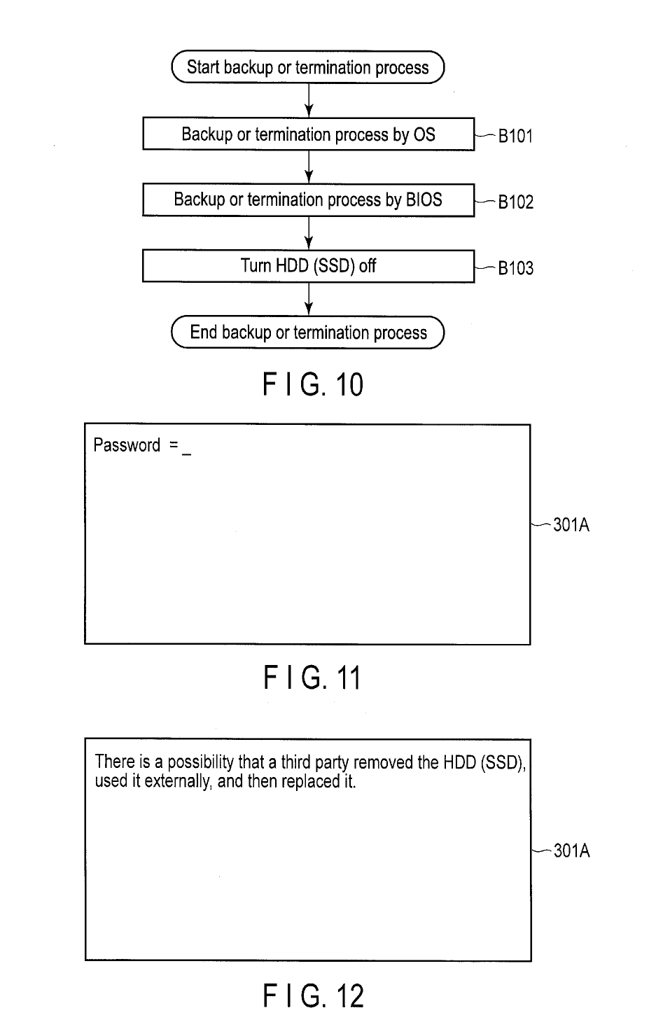

Now, this specification explains the backup process or the termination process in block B48 with reference to FIG. 10. FIG. 10 is an exemplary flowchart showing the procedure of the backup process or the termination process.

The operating system 202 performs a backup process for transitioning the computer 10 to a sleep state or a hibernation state, or a termination process for shutting down the computer 10 (block B101). When the operating system 202 finished the backup process or the termination process, the BIOS program 201 performs a backup process for transitioning the computer 10 to a sleep state or a hibernation process, or a termination process for shutting down the computer 10 (block B102). The backup process or termination process includes preparation for turning the HDD (SSD) 117 off relative to the HDD (SSD) 117.

The BIOS program 201 turns the HDD (SSD) 117 off (block B103). Subsequently, the BIOS program 201 continues the process and transitions the computer 10 to a sleep state or a hibernation state or shuts down the computer 10.

Referring to FIG. 7, this specification explains a process performed if the BIOS program 201 determines that a key has been pressed in block B46 (Yes in block B46). If the BIOS program 201 determines that a key has been pressed (Yes in block B46), the BIOS program 201 determines whether or not a user password is set (block B61). If the BIOS program 201 determines that a user password is not set (No in block B61), the BIOS program 201 continues the return process of returning the computer 10 from a hibernation state or a sleep state, or the boot process of booting the computer 10 (block B69).

If the BIOS program 201 determines that a user password is set (Yes in block B61), the BIOS program 201 sets the value i indicating how many times a user password has been input to zero (block B62). The BIOS program 201 displays a screen for requesting user password input on the display screen 301A of the display monitor 301 as shown in FIG. 11 (block B63). The user inputs a user password, using the keyboard 302 (block B64). The BIOS program 201 determines whether or not the input user password is correct (block B65). If the BIOS program 201 determines that the input user password is correct (Yes in block B65), the BIOS program 201 continues the return process of returning the computer 10 from a hibernation state or a sleep state, or the boot process of booting the computer 10 (block B69).

If the BIOS program 201 determines that the input user password is incorrect (No in block B65), the BIOS program 201 sets the value i to the value obtained by adding one to the original value i (block B66). The BIOS program 201 determines whether or not the value i is greater than three (block B67). If the BIOS program 201 determines that the value i is not greater than three (No in block B67), the BIOS program 201 executes the process from block B64 in series. If the BIOS program 201 determines that the value i is greater than three (Yes in block B67), the BIOS program 201 performs a backup process for returning the computer 10 from an activate state to the original inactive state or a termination process as explained with reference to FIG. 3 (block B68).

Referring to FIG. 6, this specification explains a process performed if the BIOS program 201 determines that a supervisor password is set in block B41 shown in FIG. 5 (Yes in block B41). If the BIOS program 201 determines that a supervisor password is set (Yes in block B41), the BIOS program 201 displays the following message on the display screen 301A of the display monitor 301 as shown in FIG. 12 (block B51): “There is a possibility that a third party removed the HDD (SSD), used it externally, and then replaced it.” After a certain period, the BIOS program 201 displays the following message on the display screen 301A of the display monitor 301 as shown in FIG. 13 (block B52): “If a certain key input is performed, the user assumes that there is no problem. Return or boot processing will then be continued.”

The BIOS program 201 determines whether or not the computer 10 is communicable with the management server 20 as an external device (block B53). If the BIOS program 201 determines that the computer 10 is communicable with the management server (Yes in block B53), the BIOS program 201 transmits, to the management server 20, a problem occurrence alert indicating the possibility that a third party removed the HDD (SSD), used it externally, and replaced it in the computer 10 (block B54). By notifying the management server 20 of a problem occurrence alert, the administrator who manages the computer 10 can know that there is a possibility that a third party removed the HDD (SSD), used it externally, and replaced it in the computer 10.

The BIOS program 201 waits for the power switch 16 or a key on the keyboard 302 to be operated (block B55). The BIOS program 201 determines whether or not a key has been pressed (block B56). If the BIOS program 201 determines that no key has been pressed (No in block B56), the BIOS program 201 determines whether or not the power switch 16 has been pressed (block B57). If the BIOS program 201 determines that the power switch 16 has been pressed (Yes in block B57), the BIOS program 201 performs a backup process for returning the computer 10 from an activate state to the original inactive state or a termination process as explained with reference to FIG. 10 (block B58).

If the BIOS program 201 determines that the power switch 16 has not been pressed (No in block B57), the BIOS program 201 executes the process from block B56 in series after a certain period.

If the BIOS program 201 determines that a key has been pressed in block B56 (Yes in block B56), the BIOS program 201 displays a screen for requesting supervisor user password input on the display screen 301A of the display monitor 301 as shown in FIG. 15 (block B59).

Now, this specification explains a process performed after block B59 with reference to FIG. 8. The BIOS program 201 sets the value i indicating how many times a supervisor password has been input to zero (block B71). The BIOS program 201 waits for the power switch 16 or a key on the keyboard 302 to be operated (block B72). If the power switch 16 or a key is operated, the BIOS program 201 determines whether or not the power switch 16 has been pressed (block B73). If the BIOS program 201 determines that the power switch 16 has been pressed (Yes in block B73), the BIOS program 201 performs a backup process for returning the computer 10 from an activate state to the original inactive state or a termination process as explained with reference to FIG. 10 (block B78).

If the BIOS program 201 determines that the power switch 16 has not been pressed (No in block B73), the BIOS program 201 determines whether or not the input supervisor password is correct (block B74).

If the BIOS program 201 determines that the input supervisor password is incorrect (No in block B74), the BIOS program 201 sets the value i to the value obtained by adding one to the original value i (block B75). The BIOS program 201 determines whether or not the value i is greater than three (block B76). If the BIOS program 201 determines that the value i is not greater than three (No in block B76), the BIOS program 201 executes the process from block B72 in series. If the BIOS program 201 determines that the value i is greater than three (Yes in block B76), the BIOS program 201 performs a backup process for returning the computer 10 from an activate state to the original inactive state or a termination process as explained with reference to FIG. 3 (block B77).

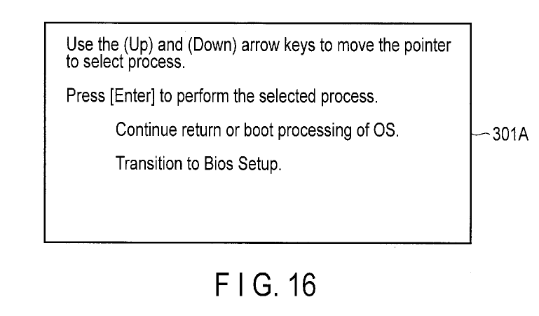

If the BIOS program 201 determines that the input supervisor password is correct in block B74 (Yes in block B74), the BIOS program 201 displays a screen for allowing the user to select a process from “Continue return or boot processing of OS” and “Transition to Bios Setup” on the display screen 301A of the display monitor 301 as shown in FIG. 16 (block B79).

Now, this specification explains a process performed after block B79 with reference to FIG. 9. The BIOS program 201 waits for the power switch 16 or a key on the keyboard 302 to be operated (block B81). If a key or the power switch 16 is operated, the BIOS program 201 determines whether or not the power switch 16 is operated (block B82). If the BIOS program 201 determines that the power button has been pressed (Yes in block B82), the BIOS program 201 performs a backup process for returning the computer 10 from an activate state to the original inactive state or a termination process as explained with reference to FIG. 10 (block B91).

If the BIOS program 201 determines that the power switch 16 has not been pressed (No in block B82), the BIOS program 201 determines whether or not “Continue return or boot processing of OS” has been selected (block B83). If the BIOS program 201 determines that “Continue return or boot processing of OS” has been selected (Yes in block B83), the BIOS program 201 continues the return process of returning the computer 10 from a hibernation state or a sleep state or the boot process of booting the computer 10 (block B92). The administrator may remove the HDD (SSD) 117 from the computer 10 and replace it in the computer 10. If the administrator removed the HDD (SSD) 117 and replaced it in the computer 10, the administrator can continue the return process of returning the computer 10 or the boot process of booting the computer 10 by inputting the correct supervisor password and selecting “Continue return or boot processing of OS”.

If the BIOS program 201 determines that “Continue return or boot processing of OS” has not been selected (No in block B83), the BIOS program 201 determines whether or not “Transition to Bios Setup” has been selected (block B84). If the BIOS program 201 determines that “Transition to Bios Setup” has not been selected (No in block B84), the BIOS program 201 performs the process from block B81 in series. If the BIOS program 201 determines that “Transition to Bios Setup” has been selected (Yes in block B84), the BIOS program 201 displays the BIOS Setup screen on the display screen 301A of the display monitor 301 (block B85).

The BIOS program 201 waits for the power switch 16 or a key on the keyboard 302 to be operated (block B86). If a key or the power switch 16 has been operated, the BIOS program 201 determines whether or not the power switch 16 has been operated (block B87).

If the BIOS program 201 determines that the power switch 16 has not been operated (No in block B87), the BIOS program 201 determines whether or not shutdown has been selected during BIOS setup (block B89). If the BIOS program 201 determines that shutdown has not been selected during BIOS setup (No in block B89), the BIOS program 201 performs the process from block B86 in series.

If the BIOS program 201 determines that shutdown has been selected during BIOS setup (Yes in block B89), or the BIOS program 201 determines that the power switch 16 has been operated (Yes in block B87), the BIOS program 201 performs a backup process for returning the computer 10 from an active state to the original inactive state or a termination process as explained with reference to FIG. 3 (block B93).

As stated above, if a process including a procedure of turning the HDD (SSD) 117 off is performed, before the HDD (SSD) 117 is turned off, the computer 10 of the present embodiment stores, in the nonvolatile memory 117B, first data which is stored in the nonvolatile memory 117B of the HDD (SSD) 117 and which indicates how many times the HDD (SSD) 117 has been turned on as second data. The computer 10 determines whether or not use of the data in the data storage portion 117A should be permitted based on a first number indicated by the first data and a second number indicated by the second data prior to the use of the data in the data storage portion 117A when the HDD (SSD) 117 is turned on in order to use the data in the data storage portion 117A of the HDD (SSD) 117. By the above process, it is possible to prevent leakage of data on the network A connected to the computer 10 by spyware or spread of a computer virus or spyware to other computers connected to the network A if there is a possibility that the HDD (SSD) 117 was removed.

Various processes of the present embodiment may be realized by a computer program. Thus, effects similar to those of the present embodiment may be easily obtained by merely installing the computer program into a computer through a computer-readable storage medium in which the computer program is stored.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiment described herein may be made without departing from the spirit of the invention. The accompanying claims and their equivalents are intended to cover such forms or modifications as would fall within the scope and spirit of the inventions.

What is claimed is:

1. An electronic device comprising:
a storage device comprising a storage and a first nonvolatile memory configured to store first data, the first data indicative of the number of times the storage device has been turned on;
a second nonvolatile memory; and
a processor configured to:
store the first data as second data in the second nonvolatile memory before the storage device is turned off; and
when the storage device is turned on, determine whether access to the data in the storage is permitted based on a first number indicated by the first data and a second number indicated by the second data prior to the access to the data in the storage.

2. The electronic device of claim 1, wherein:
the processor is configured to permit the access to the data in the storage when the first number is equal to a third number, the third number the second number plus one; and
the processor is configured not to permit the access to the data in the storage when the first number is not equal to the third number.

3. The electronic device of claim 1, wherein the processor is configured to turn the storage device off when the processor determines that the access to the data in the storage is not permitted.

4. The electronic device of claim 1, wherein the processor is configured to notify an external device communicable with the electronic device that there is a possibility that the storage device was removed from the electronic device when the processor determines that the access to the data in the storage is not permitted.

5. The electronic device of claim 1, wherein the processor is configured to:
request a password input when the processor determines that the access to the data in the storage is not permitted; and
allow a user to determine whether the access to the data in the storage is permitted when the password input is correct.

6. The electronic device of claim 1, wherein the processor is configured to notify a user that there is a possibility that the storage device was removed from the electronic device when the processor determines that the access to the data in the storage is not permitted.

7. A method of controlling an electronic device comprising a storage device comprising a storage and a first nonvolatile memory in which first data is stored, the first data indicative of the number of times the storage device has been turned on, the method comprising:
storing the first data as second data in a second nonvolatile memory before the storage device is turned off; and
when the storage device is turned on, determining whether access to the data in the storage is permitted based on a first number indicated by the first data and a second number indicated by the second data prior to the access to the data in the storage.

8. The method of claim 7, further comprising:
permitting the access to the data in the storage when the first number is equal to a third number, the third number the second number plus one; and
not permitting the access to the data in the storage when the first number is not equal to the third number.

9. The method of claim 7, further comprising turning the storage device off when it is determined that the access to the data in the storage is not permitted.

10. The method of claim 7, further comprising notifying an external device communicable with the electronic device that there is a possibility that the storage device was removed from the electronic device when it is determined that the access to the data in the storage is not permitted.

11. The method of claim 7, further comprising:
requesting a password input when it is determined that the access to the data in the storage is not permitted; and
allowing a user to determine whether the access to the data in the storage is permitted when a password input is correct.

12. The method of claim 7, further comprising notifying a user that there is a possibility that the storage device was removed from the electronic device when it is determined that the access to the data in the storage is not permitted.

13. A non-transitory computer-readable storage medium having stored thereon a computer program which is executable by a computer comprising a storage device comprising a storage and a first nonvolatile memory in which first data is stored, the first data indicative of the number of times the storage device has been turned on, the computer program controlling the computer to execute functions of:
storing the first data as second data in a second nonvolatile memory before the storage device is turned off; and
when the storage device is turned on, determining whether access to the data in the storage is permitted based on a first number indicated by the first data and a second number indicated by the second data prior to the access to the data in the storage.

14. The medium of claim 13, wherein the computer program further controls the computer to execute functions of:
permitting the access to the data in the storage when the first number is equal to a third number, the third number the second number plus one; and
not permitting the access to the data in the storage when the first number is not equal to the third number.

15. The medium of claim 13, wherein the computer program further controls the computer to execute a function of turning the storage device off when it is determined that the access to the data in the storage is not permitted.

16. The medium of claim 13, wherein the computer program further controls the computer to execute a function of notifying an external device communicable with the computer that there is a possibility that the storage device was removed from the computer when it is determined that the access to the data in the storage is not permitted.

17. The medium of claim 13, wherein the computer program further controls the computer to execute functions of:
requesting a password input when it is determined that the access to the data in the storage is not permitted; and
allowing a user to determine whether the access to the data in the storage is permitted when the password input is correct.

18. The medium of claim 13, wherein the computer program further controls the computer to execute a function of notifying a user that there is a possibility that the storage device was removed from the computer when it is determined that the access to the data in the storage is not permitted.
